(19) United States
(12) Patent Application Publication
(10) Pub. No.: US 2009/0096317 A1
(43) Pub. Date: Apr. 16, 2009

(54) ROTATING MACHINE

(75) Inventors: Manabu Sasaki, Hitachi (JP); Hiroyuki Mikami, Hitachinaka (JP); Tadaharu Kishibe, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/250,608

(22) Filed: Oct. 14, 2008

(30) Foreign Application Priority Data
Oct. 16, 2007 (JP) 2007-268495

(51) Int. Cl. H02K 1/12

(52) U.S. Cl. 310/254

(57) ABSTRACT

There is provided a rotating machine including a stator and a rotor, in which the inner side surface (facing the stator) of the axial end structures of the stator is provided with grooves filled with an electrically nonconductive material.

### CLAIM OF PRIORITY

The present application claims priority from Japanese patent application serial No. 2007-268495, filed on Oct. 16, 2007, the content of which is hereby incorporated by reference into this application.

### FIELD OF THE INVENTION

The present invention relates to rotating machines, and particularly to end structures of stators.

### BACKGROUND OF THE INVENTION

Generally, ultra-high-speed rotating machines (typified by generators for micro gas-turbine systems) are designed to increase the critical speed by decreasing the bearing span of the rotor. A generator rotor in such ultra-high-speed rotating machines is directly connected to the turbine or compressor. So, the axial end portions of the generator are designed compactly and the end brackets are disposed close to the coil ends. Here, the term “coil end” refers to a coil portion positioned on an axial end of a stator (or rotor) core, where a coil side inserted in one slot is connected to another coil side in another slot.

Therefore, leakage magnetic fluxes from the coil end cause eddy current losses in the end bracket. Such eddy current losses can not only reduce generator efficiency but also cause local overheating or deformation at the locations of eddy current generation.

For example, JP-A-2005-253198 discloses a method for reducing eddy current losses in an end bracket, in which the end bracket is provided with depressions (such as slits) or projections.

### SUMMARY OF THE INVENTION

The method described in the above-mentioned JP-A-2005-253198 has some effect in reducing eddy current generation in the end bracket. However, it has a problem in that the depressions or projections radially extending from the rotation axis disturb the swirl flow generated by the rotation of the rotating body, resulting in increased windage loss and leading to reduced generator efficiency.

An object of the invention is to provide a high efficiency rotating machine by reducing eddy current losses in the stator end structures while minimizing disturbance of the swirl flow to suppress the windage loss.

A feature of the invention is to provide the stator end structures of a rotating machine with grooves filled with an electrically nonconductive material such as resin.

The invention can provide a high efficiency rotating machine by reducing eddy current losses in the stator end structures while minimizing disturbance of the swirl flow to suppress the windage loss.

### BRIEF DESCRIPTION OF THE DRAWINGS

FIG. 1 is a schematic longitudinal sectional view of a rotating machine according to a first embodiment of the invention.

FIG. 2 illustrates an end bracket of a rotating machine according to a first embodiment of the invention.

FIG. 3 illustrates an end bracket of a rotating machine according to a first embodiment of the invention.

FIG. 4 is a schematic longitudinal sectional view of a rotating machine according to a second embodiment of the invention.

FIG. 5 illustrates an end bracket of a rotating machine according to a third embodiment of the invention.

FIG. 6 illustrates an end bracket of a rotating machine according to a fourth embodiment of the invention.

FIG. 7 illustrates an end bracket of a rotating machine according to a fifth embodiment of the invention.

FIG. 8 illustrates an end bracket of a rotating machine according to a sixth embodiment of the invention.

FIG. 9 illustrates an end bracket of a rotating machine according to a seventh embodiment of the invention.

FIG. 10 illustrates an end bracket of a rotating machine according to an eighth embodiment of the invention.

FIG. 11 illustrates an end bracket of a rotating machine according to a ninth embodiment of the invention.

FIG. 12 illustrates an end bracket of a rotating machine according to a tenth embodiment of the invention.

### DESCRIPTION OF THE PREFERRED EMBODIMENTS

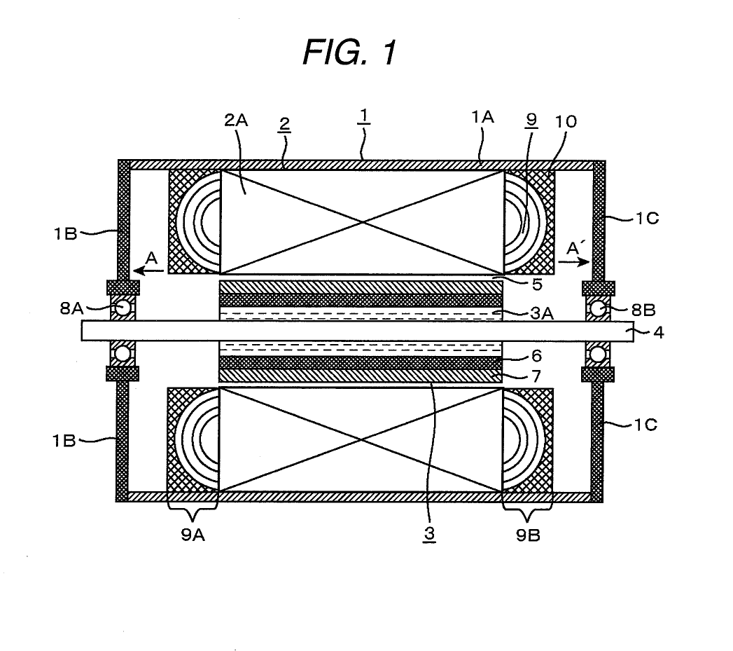

A rotating machine according to a first embodiment of the invention will be described below with reference to FIGS. 1, 2 and 3.

The rotating machine according to the first embodiment is a high-speed generator for use in a micro gas turbine and a permanent magnet rotating machine having permanent magnets mounted on its rotor. FIG. 1 is a schematic longitudinal sectional view of the rotating machine according to the first embodiment. This rotating machine essentially includes: a housing 1 formed by bolting (not shown) substantially disc-shaped end brackets 1B and 1C to a housing cylinder 1A; bearings 8A and 8B fixed to the housing 1 and rotatably supporting a rotary shaft 4; a rotor 3 fixed to the rotary shaft 4; and a stator 2 surrounding the rotor 3 and fixed to the housing 1 with an air gap 5 formed between the rotor 3 and stator 2. The stator 2 is formed into a cylindrical shape by laminating thin ring-like magnetic steel sheets 2A and is provided with multiple slots (not shown) for inserting coils 9. Each coil 9 is a copper winding coated with an insulation layer, which is formed by inserting a copper wire in the slots (not shown) and winding it around the stator 2. Here, each coil 9 is wound in such a manner that it is extended out of a slot at an axial end face of the stator 2 where it is folded and inserted into another slot (not shown). Hereinafter, the opposite end portions of each coil 9 on the axial end faces of the stator 2 where the coil 9 is folded are referred to as the coil ends 9A and 9B. The coil ends 9A and 9B are covered with a resin 10. Thereby, the coil ends 9A and 9B can be cooled efficiently.

Permanent magnets 6 are disposed along the outer periphery of the core 3A of the rotor 3 and a holding tube 7 is provided over the magnets 6 to prevent the magnets from flying off. To the rotary shaft 4 is connected a compressor and a turbine (neither shown).

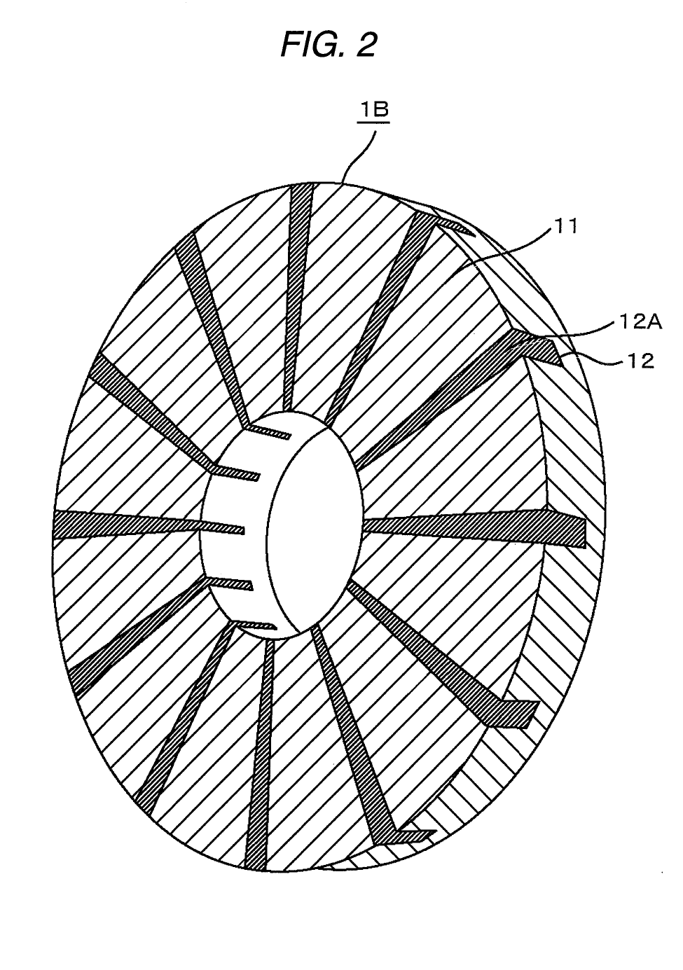

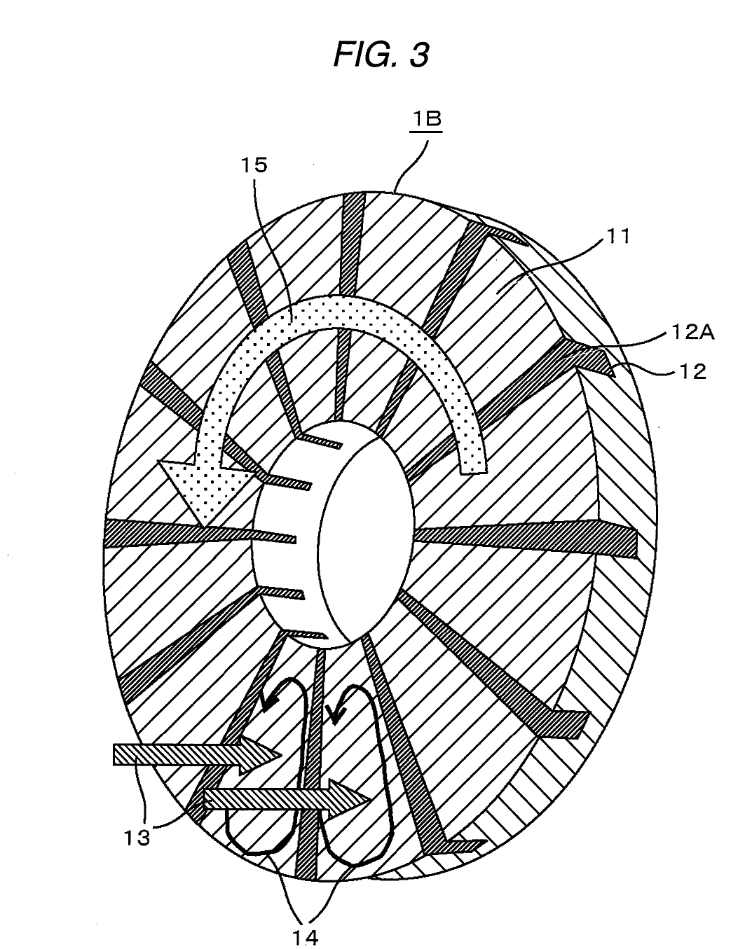

FIG. 2 illustrates the end bracket 1B as viewed in the A direction of FIG. 1. The end bracket 1B is provided with multiple radial grooves 12 filled with an electrically nonconductive material 12A such as a resin. The resin is preferably a high-temperature curing epoxy resin or the like. FIG. 3 illustrates the end bracket 1B as viewed in the A direction of FIG. 1 to explain how eddy currents are generated. In operation of the generator, leakage magnetic fluxes 13 from the coil end (not shown) and the rotor's permanent magnets (not shown) induce eddy currents in the surfaces of the conductor portions 11 of the end bracket 1B, thus causing eddy current losses. Such provision of the end bracket 1B with the grooves 12 shortens the path length of each eddy current, thus resulting in a reduction in the eddy current losses. In this case, provision of the grooves alone can disturb the swirl flow 15, resulting in an increased windage loss. However, the filling of the grooves 12 with an electrically nonconductive material 12A (such as a resin) can suppress such disturbance of the swirl flow 15 while achieving the shortening of eddy current path lengths, and therefore a high efficiency rotating machine can be obtained. It is needless to say that the rotation direction of the swirl flow 15 is opposite to that of FIG. 3 when the end bracket 1C is viewed in the A′ direction of FIG. 1.

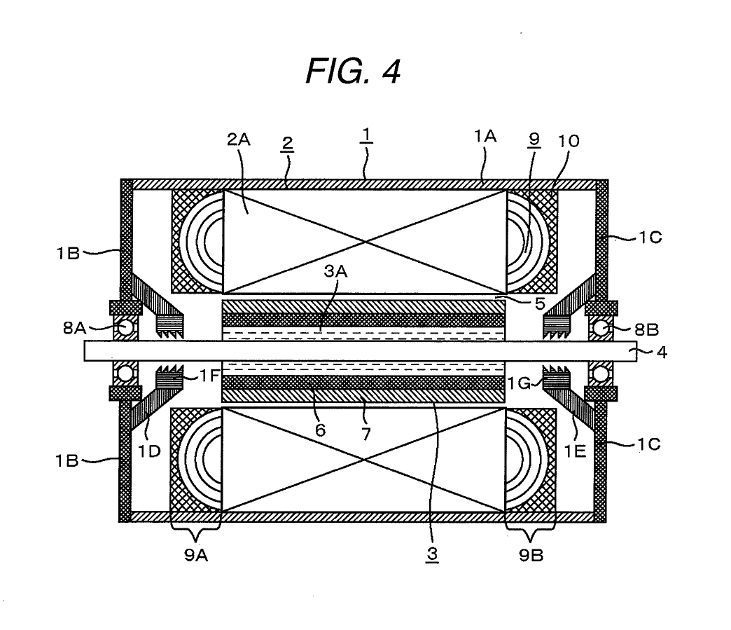

Next, a rotating machine according to a second embodiment of the invention will be described with reference to FIG. 4. The same parts as in FIGS. 1-3 are designated by the same reference numerals without repeating the detailed description thereof. In the second embodiment, the bearings 8A and 8B are sliding bearings. A bearing lubricant, oil or water, is provided between the rotary shaft 4 and each of the sliding bearings 8A and 8B. And, labyrinth rings 1F and 1G are provided in order to prevent leakage of the lubricant. The labyrinth rings 1F and 1G are fixed to the end brackets 1B and 1C via labyrinth ring supports 1D and 1E, respectively. The labyrinth rings 1F and 1G and the labyrinth ring supports 1D and 1E are also made from a conductor, and therefore leakage magnetic fluxes (not shown) cause eddy current losses also in such members in the same way as in the end brackets 1B and 1C. Similarly to the end bracket shown in FIG. 2, the labyrinth rings 1F and 1G and the labyrinth ring supports 1D and 1E are each provided with a plurality of radial grooves (not shown), which are then filled with an electrically nonconductive material such as a resin (not shown). In this manner, disturbance of the swirl flow 15 can be minimized while achieving shortening of eddy current path lengths, and thus a high efficiency rotating machine can be obtained. It is to be added that the labyrinth ring 1F and the labyrinth ring support 1D constitute one labyrinth seal and the labyrinth ring 1G and the labyrinth ring support 1E constitute the other.

As described above, a feature of the invention is that the inner side surfaces of the stator's end structures (such as end brackets, labyrinth rings and labyrinth ring supports) of a rotating machine are provided with radial grooves filled with an electrically nonconductive material. This can reduce eddy currents while minimizing disturbance of the swirl flow (and therefore minimizing the windage loss). Thus, a high efficiency rotating machine can be provided.

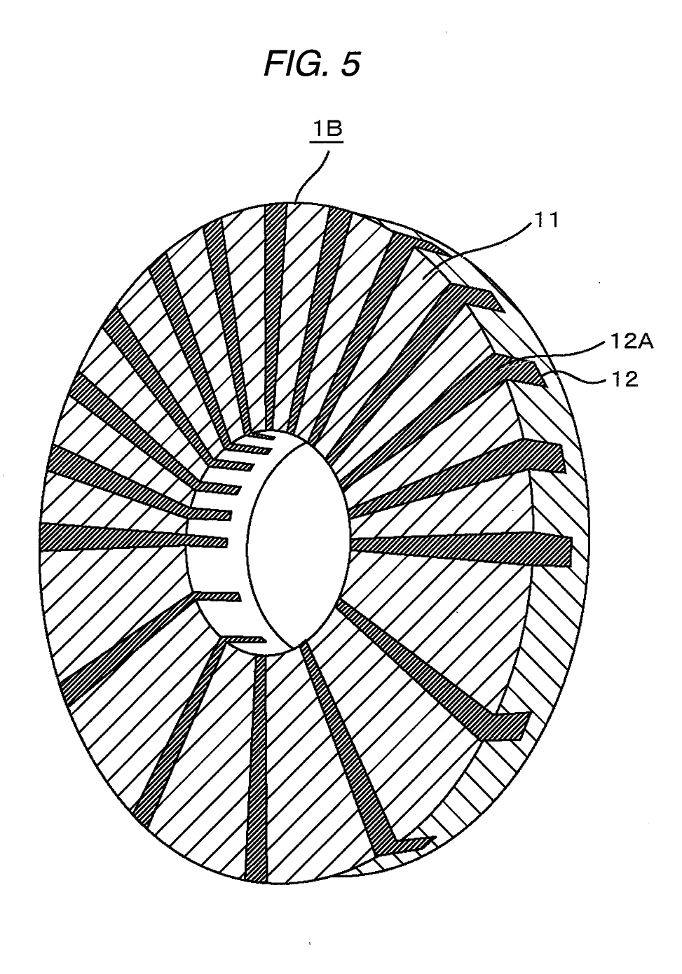

Next, a rotating machine according to a third embodiment of the invention will be described with reference to FIG. 5. The same parts as in FIGS. 1-3 are designated by the same reference numerals without repeating the detailed description thereof. In the third embodiment, radial grooves provided in each stator end structure are circumferentially unequally spaced so that the number of the grooves in the top half is greater than that in the bottom half. With this configuration, eddy currents generated in the top half are less than those in the bottom half. So, when the temperature of the upper portion is higher than that of the lower portion, such a temperature difference can be reduced. Generally, heat tends to build up in the upper portion of a rotating machine. So, in order to reduce heat generation in the upper portion, eddy current generation in the top half of each stator end structure is reduced by narrowing the groove pitch in the top half compared to that in the bottom half. In this manner, such temperature distribution in a rotating machine can be uniformized.

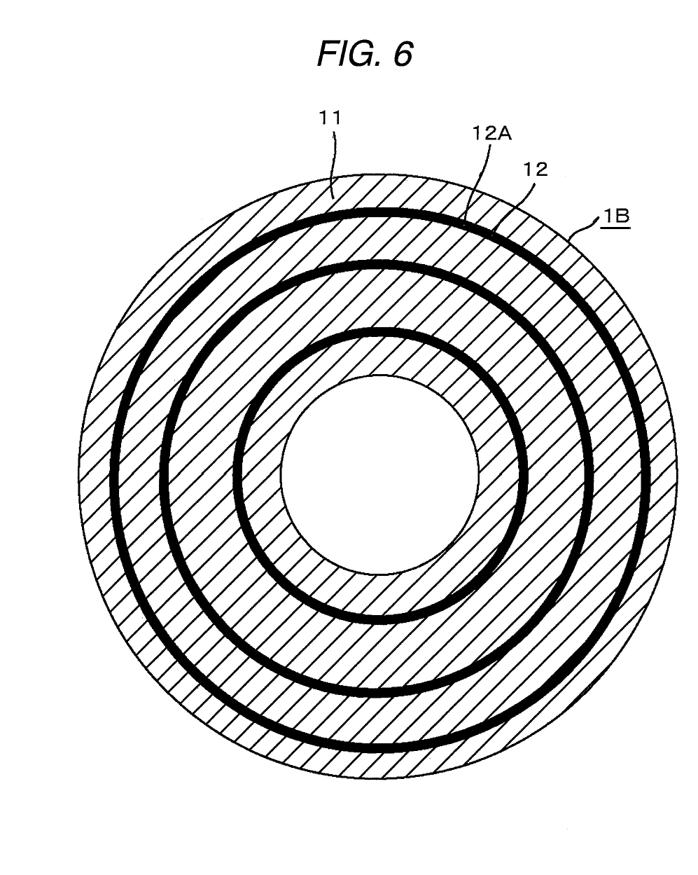

Next, a rotating machine according to a fourth embodiment of the invention will be described with reference to FIG. 6. The same parts as in FIGS. 1-3 are designated by the same reference numerals without repeating the detailed description thereof. In the fourth embodiment, annular grooves are provided in each stator end structure. This configuration can also shorten eddy current path lengths while minimizing disturbance of swirl flow (not shown), and thus, a high efficiency rotating machine can be obtained.

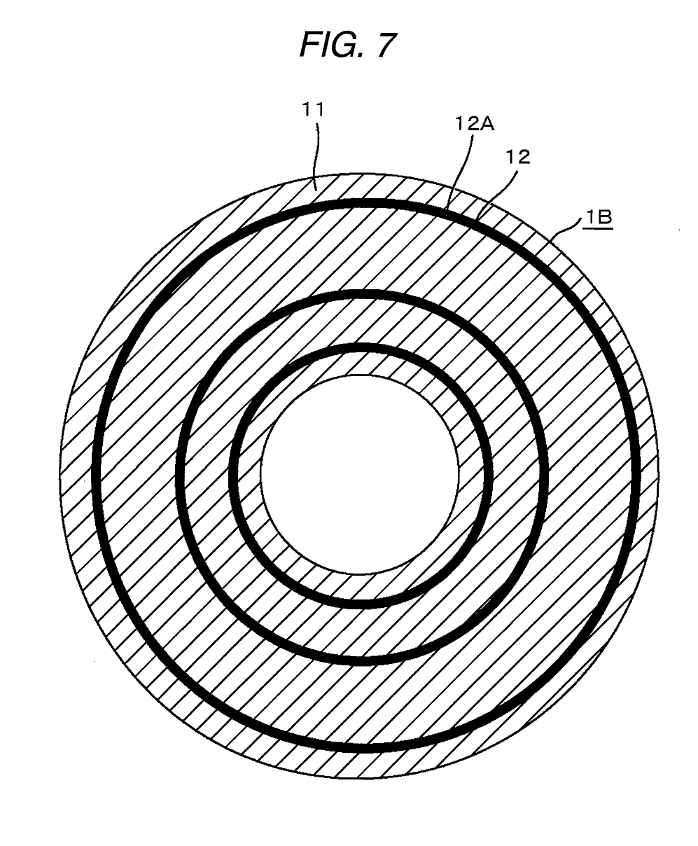

Next, a rotating machine according to a fifth embodiment of the invention will be described with reference to FIG. 7. The same parts as in FIGS. 1-3 are designated by the same reference numerals without repeating the detailed description thereof. In the fifth embodiment, each stator end structure is provided with annular grooves, and the annular grooves are radially unequally spaced, i.e., the radial pitches of the annular grooves are different. More eddy current loss occurs in the inner peripheral area of each stator end structure than in the other areas. So, eddy current losses can be efficiently reduced by increasing the relative number of annular grooves in the inner peripheral area while minimizing disturbance of swirl flow (not shown). Thus, a high efficiency rotating machine can be obtained.

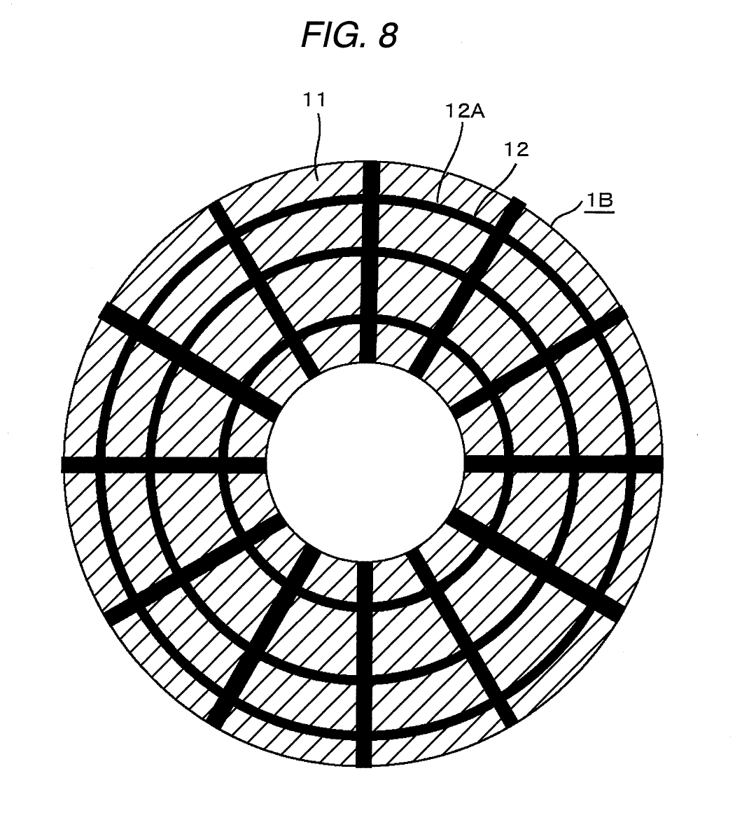

Next, a rotating machine according to a sixth embodiment of the invention will be described with reference to FIG. 8. The same parts as in FIGS. 1-3 are designated by the same reference numerals without repeating the detailed description thereof. In the sixth embodiment, both radial grooves and annular grooves are provided in the inner side surface of each stator end structure. This configuration can also shorten each eddy current path length while minimizing disturbance of swirl flow (not shown), and thus, a high efficiency rotating machine can be obtained.

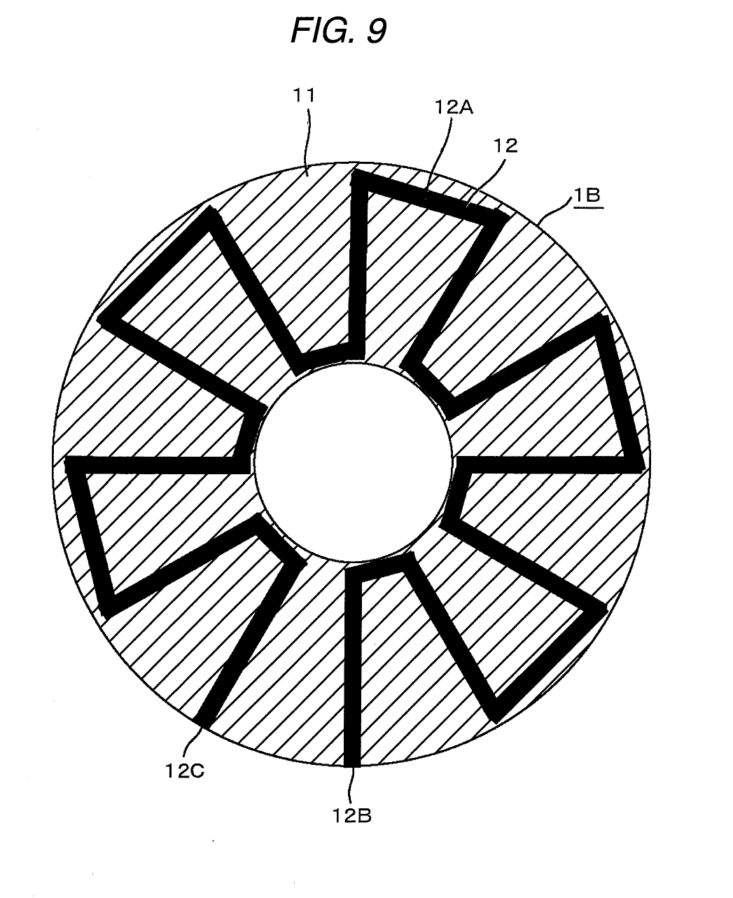

Next, a rotating machine according to a seventh embodiment of the invention will be described with reference to FIG. 9. The same parts as in FIGS. 1-3 are designated by the same reference numerals without repeating the detailed description thereof. In the seventh embodiment, the end bracket 1B is provided with a continuous groove formed by connecting multiple grooves, and the continuous groove has two openings (12B and 12C) exposed to the outer circumferential surface of the end bracket 1B. This configuration can facilitate the filling of the groove with a resin in the following manner: That is, an end bracket 1B provided with such a continuous groove is fastened (e.g., bolted [not shown]) to another unshown bracket 1B (of the same shape) without any groove, and the two openings 12B and 12C are positioned upward. Then, a resin is fed from the inlet opening 12B and is forced out of the outlet opening 12C. In addition, each of the two openings of the groove may be exposed to either the inner or outer circumferential surface of each stator end structure (such as the end bracket). Also, the groove does not necessarily require two openings, but may have only one opening.

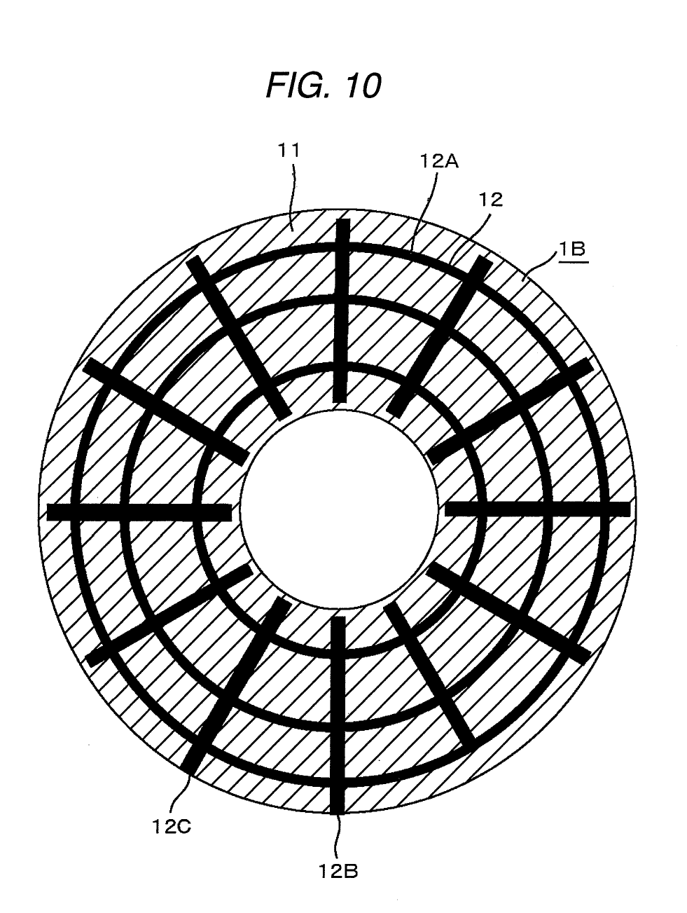

Next, a rotating machine according to an eighth embodiment of the invention will be described with reference to FIG. 10. The same parts as in FIGS. 1-3 are designated by the same reference numerals without repeating the detailed description thereof. In the eighth embodiment, the inner side surface of the end bracket 1B is provided with a continuous groove formed by connecting radial and annular grooves. And the continuous groove has two openings (12B and 12C) exposed to the outer circumferential surface of the end bracket 1B. This configuration can also facilitate the filling of the groove with a resin in the following manner: That is, an end bracket 1B provided with such a continuous groove is fastened (e.g., bolted [not shown]) to another unshown bracket 1B (of the same shape) without any groove, and the two openings 12B and 12C are positioned upward. Then, a resin is fed from the inlet opening 12B and is forced out of the outlet opening 12C.

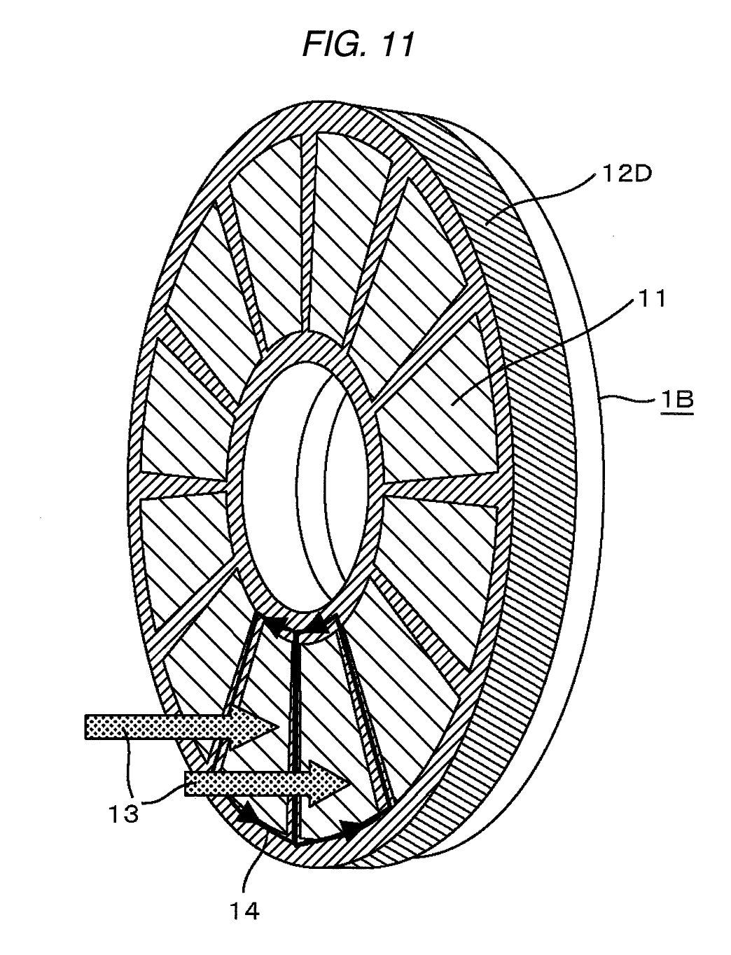

Next, a rotating machine according to a ninth embodiment of the invention will be described with reference to FIG. 11. The same parts as in FIGS. 1-3 are designated by the same reference numerals without repeating the detailed description thereof. In the ninth embodiment, the inner side surface of each stator end structure (such as the above-mentioned end bracket) is provided with grooves extended in a net-like manner. And, multiple conductor rings are inserted in the grooves. The conductor is preferably low resistivity copper. The copper ring may be formed by bending a copper bar or by die-casting copper. The leakage magnetic flux 13 induces an eddy current 14 in a copper ring in such a direction as to substantially cancel the leakage magnetic flux 13; thus, the eddy current loss generated in the conductor portion 11 of the end bracket 1B can be reduced. The eddy current 14 flowing in the copper ring is itself a loss of power; however, since the resistivity of copper is low, the total loss combined with the eddy current loss generated in the conductor portion 11 decreases. In addition, the copper ring, a good heat conductor, is readily cooled through the conductor portion 11 and the swirl flow (not shown) thus causing almost no local overheating. This configuration can also reduce eddy current losses while minimizing disturbance of swirl flow (not shown), and thus, a high efficiency rotating machine can be obtained. Furthermore, aluminum may be used instead of copper.

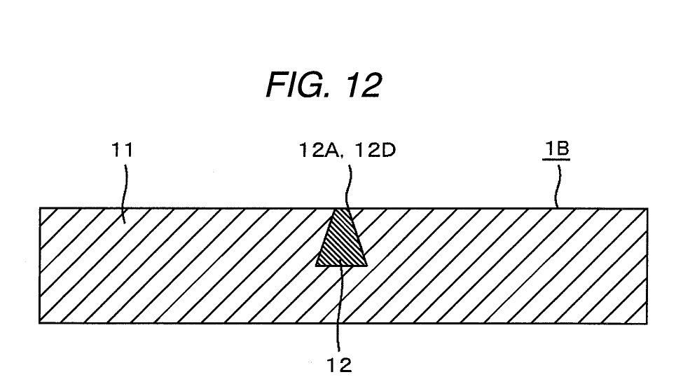

Next, a rotating machine according to a tenth embodiment of the invention will be described with reference to FIG. 12. The same parts as in FIGS. 1-3 are designated by the same reference numerals without repeating the detailed description thereof. In the tenth embodiment, the above-described groove is formed in a dovetail shape so that its bottom width is greater than its surface opening width. This shape can prevent removal of the above-described poured-and-cured resin or the die-cast copper ring.

What is claimed is:

1. A rotating machine including a stator and a rotor, wherein the inner side surface (facing the stator) of an axial end structure of the stator is provided with a groove filled with an electrically nonconductive material.

2. The rotating machine according to claim 1, wherein the stator end structure is an end bracket of a housing containing the stator.

3. The rotating machine according to claim 1, wherein the stator end structure is a labyrinth seal supported by an end bracket of a housing containing the stator.

4. The rotating machine according to claim 1, wherein the groove is extended substantially radially.

5. The rotating machine according to claim 4, wherein the groove includes a plurality of substantially radial sub-grooves that are circumferentially unequally spaced.

6. The rotating machine according to claim 1, wherein the groove is extended substantially annularly.

7. The rotating machine according to claim 6, wherein the groove includes a plurality of substantially annular sub-grooves that are radially unequally spaced.

8. The rotating machine according to claim 1, wherein the groove has an opening exposed to the outer or inner circumferential surface of the stator end structure.

9. The rotating machine according to claim 1, wherein the groove has a cross section in which its bottom width is greater than its surface opening width.

10. A rotating machine including a stator and a rotor, wherein the inner side surface (facing the stator) of an axial end structure of the stator is provided with a groove that is extended in a net-like manner; and an electrical conductor ring is inserted in the groove.

11. The rotating machine according to claim 10, wherein the electrical conductor ring is die-cast.

12. The rotating machine according to claim 11, wherein the groove has a cross section in which its bottom width is greater than its surface opening width.

13. The rotating machine according to claim 10, wherein the electrical conductor ring is made from copper or aluminum.
